(19) United States
(12) Patent Application Publication
(10) Pub. No.: US 2013/0125795 A1
(43) Pub. Date: May 23, 2013

(54) Folding Model Train Layout Table

(71) Applicant: John R. Burke, New York, NY (US)

(72) Inventor: John R. Burke, New York, NY (US)

(73) Assignee: JOHN RICARDO BURKE, NEW YORK, NY (US)

(21) Appl. No.: 13/090,126

(22) Filed: Nov. 17, 2011

(51) Int. Cl. A47B 5/06; A47B 5/04; B23P 11/00

(52) U.S. Cl. 108/48; 29/428

(57) ABSTRACT

The Folding Model Train Layout Table is intended to be used by model railroaders or other hobbyist to create a scenic layout that can be stored in a folded position on vertical surface. In the folded position the surface would resemble a three dimensional piece of wall art.

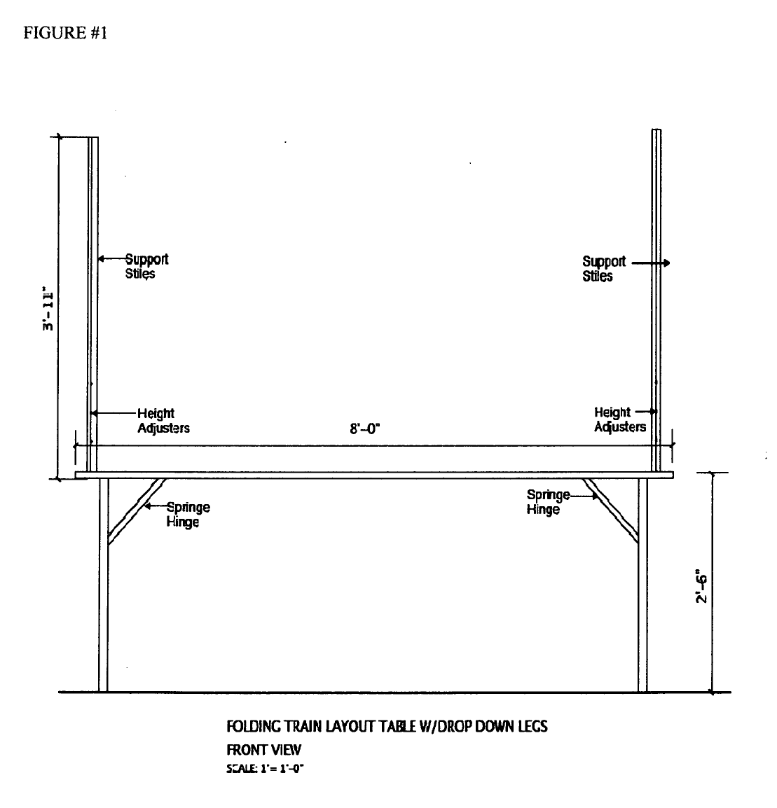

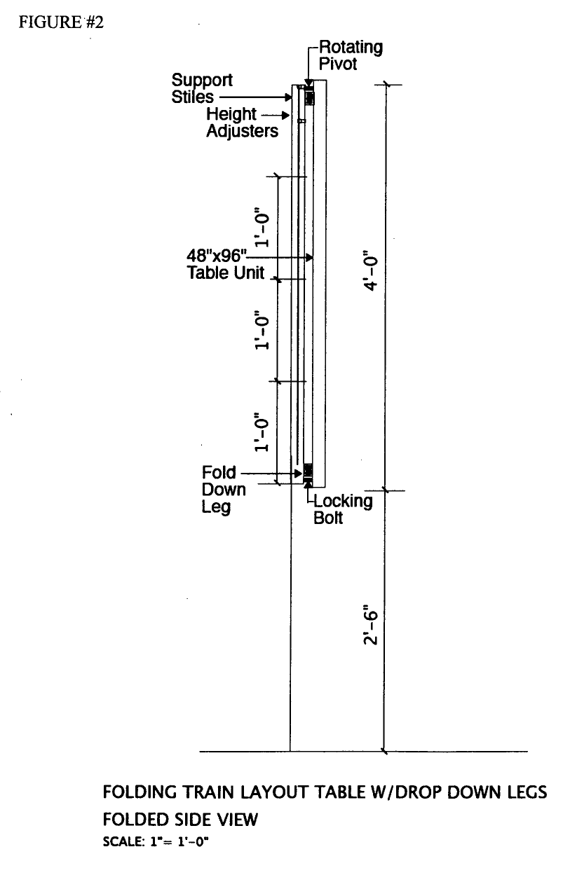

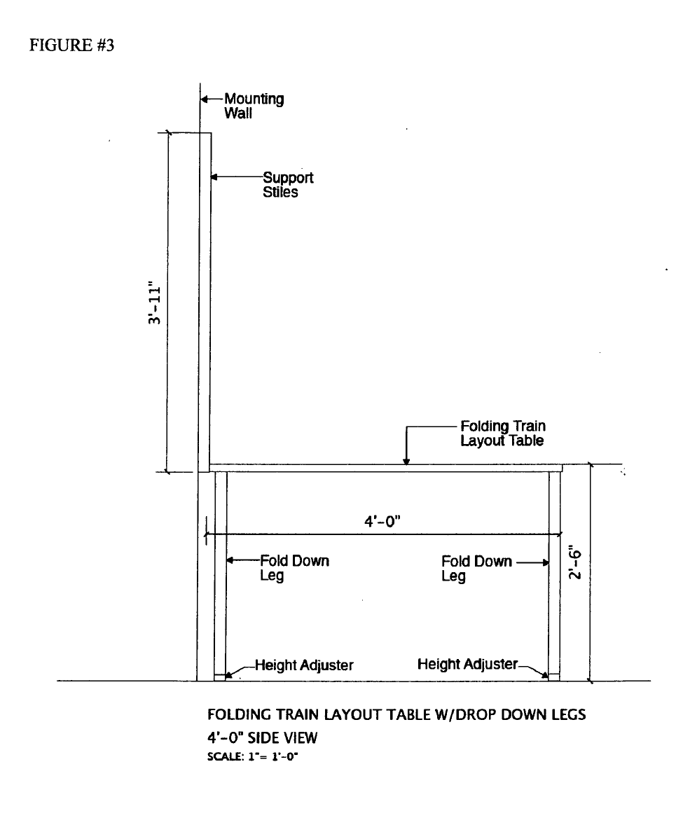

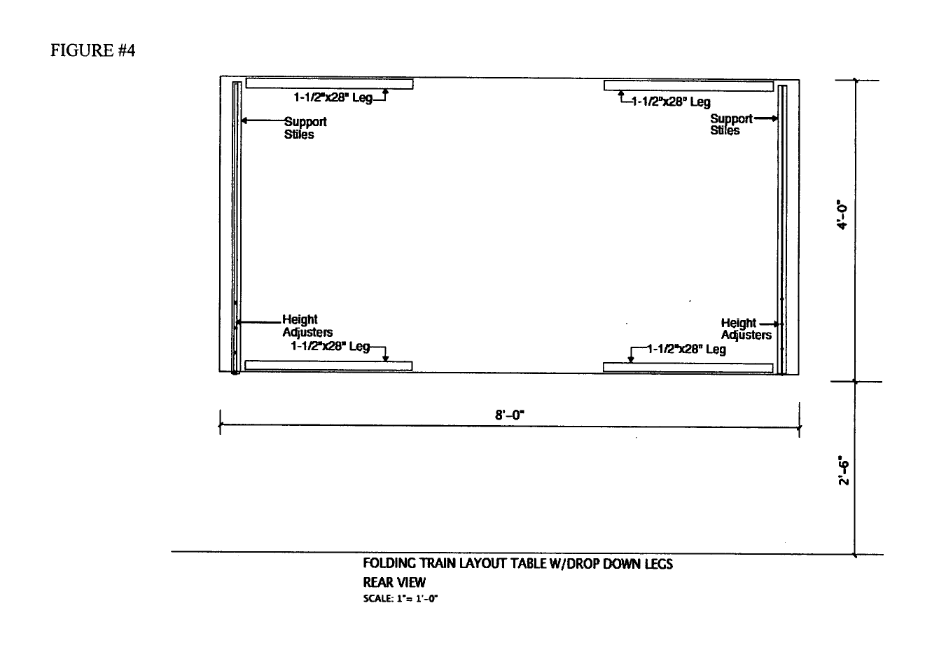

### BACKGROUND OF THE INVENTION

This application contains the specifications for the invention of a Folding Model Train Layout Table with front and rear drawings. Model railroaders with limited space will have the ability to setup a layout that can be easily stored on the wall creating a three dimensional art work.

### BRIEF SUMMARY OF THE INVENTION

The Folding Model Train Layout Table can be used by anyone who is short on space but would still like to have a table to run their trains on. The table would allow the construction of a layout large enough to run model trains of various scales and space for scenery. The table would be affixed to a wall on one end and would allow the user to easily slide the layout to a closed position on the wall when not in use. In this position the layout would create a three dimensional art work of the scenery and tracks.

### BREIEF DESCRIPTION OF THE SEVERAL VIEWES OF THE DRAWING

FIG. #1 is a front view with the dimensions of the Folding Model Train Layout Table with the legs extended to the floor and the wall supports exposed.

FIG. #2 is a side view with the dimensions of the Folding Model Train Layout Table in the closed position.

FIG. #3 is a side view with the dimensions of the Folding Model Train Layout Table showing all four legs in the extended position.

FIG. #4 is a rear view with the dimensions of the Folding Model Train Layout Table in the closed position

### DETAILED DESCRIPTION OF THE INVENTION

1. For this purpose and design the size of the table will be 4 ft by 8 ft made from a light weight material. In FIG. #1, the front view it shows the support stiles that would attach to the wall using heavy duty screws and have height adjusters. There will be two support stiles each 3 ft 11 ins long which will be attached to the wall. The stiles would be 2 ft 6 ins from the ground. In order for the table to be attached to the stiles, the underside of the table would have four rotating pivots that would slide into the stiles, as shown in FIG. #2. The two rotating pivots at the top of the table would allow the attachment of the table to the stiles which would then slide upward (top facing out) the two rotating pivots at the bottom would rest in a locking bolt, as shown in FIG. #2, preventing the table from unfolding from the closed position.

2. To open the table the bottom rotating pivots should be lifted out of the locking bolt which would allow the top rotating pivots to slide downwards along the stiles. When the table has reached the bottom of the stiles it will lock in place preventing it from becoming detached from the wall. The underside of the table will be affixed with four legs at either side of the span of the table, as shown in FIG. #4. As the table is sliding to the open position the front legs should be pulled open and locked in place to support the table. The legs will lock into place using spring hinges and will have adjustable height screws on their ends for stability, as shown in FIG. #3. In the fully opened position the table would be 2 ft 6 ins from the ground.

As shown in the side view in FIG. #3, the back of the table will remain attached to the stiles by the rotating pivots. To remove the table completely from the stiles; the rear legs should be extended and locked into position before releasing the rear rotating pivots in order to support the entire structure.

3 In order to gain a better understanding of what the rear of the Folding Model Train Layout Table comprises, FIG. #4 shows the four legs in the folded position along with the supporting stiles.

1. For this purpose and design the size of the Folding Model Train Layout Table will be 4 ft by 8 ft made from a light weight material. In FIG. #1, the front view it shows the support stiles that would attach to the wall using heavy duty screws and have height adjusters.

2. The method of claim 1, wherein there will be two support stiles each 3 ft 11 ins long which will be attached to a wall.
The stiles will be 2 ft 6 ins from the ground. In order for the table to be attached to the stiles, the underside of the table will have four rotating pivots that would slide into the stiles, as shown in FIG. #2.

3. The method of claim 2, where in the two rotating pivots at the top of the table would allow the attachment of the table to the stiles which would then slide upward (top facing out) the two rotating pivots at the bottom would rest in a locking bolt, as shown in FIG. #2, preventing the table from unfolding from the closed position.

4. The method of claim 3, wherein to open the table the bottom rotating pivots should be lifted out of the locking bolt which would allow the top rotating pivots to slide downwards along the stiles.

5. The method of claim 4, wherein when the table has reached the bottom of the stiles it will lock in place preventing it from becoming detached from the wall. The underside of the table will be affixed with four legs at either side of the span of the table, as shown in FIG. #4.

6. The method of claim 4, wherein as the table is sliding to the open position the front legs should be pulled open and locked in place to support the table.

7. The method of claim 4, wherein the legs will lock into place using spring hinges and will have adjustable height screws on their ends for stability, as shown in FIG. #3.

8. The method of claim 5, wherein in the fully opened position the table would be 2 ft 6 ins from the ground.

9. The method of claim 6, wherein as shown in the side view in FIG. #3, the back of the table will remain attached to the stiles by the rotating pivots.

10. The method of claim 7, wherein to remove the table completely from the stiles; the rear legs should be extended and locked into position before releasing the rear rotating pivots in order to support the entire structure.

11. The method of claim 8, wherein in order to gain a better understanding of what the rear of the Folding Model Train Layout Table comprises, FIG. #4 shows the four legs in the folded position along with the supporting stiles.
